(19) United States
(12) Patent Application Publication
(10) Pub. No.: US 2018/0163078 A1
(43) Pub. Date: Jun. 14, 2018

(54) SYNTHETIC POLYMERIC ANTIOXIDANTS FOR CORROSION PROTECTION

(71) Applicant: The Texas A&M University System, College Station, TX (US)

(72) Inventors: Svetlana A. Sukhishvili, College Station, TX (US); Raman Hlushko, College Station, TX (US); Hanna Hlushko, College Station, TX (US); Yenny Paola Cubides Gonzalez, College Station, TX (US); Homero Castaneda-Lopez, College Station, TX (US)

(21) Appl. No.: 15/841,244

(22) Filed: Dec. 13, 2017

Related U.S. Application Data
(60) Provisional application No. 62/433,780, filed on Dec. 13, 2016.

(51) Int. Cl. C09D 133/26; C08F 220/58; C09D 5/08

(52) U.S. Cl. CPC C09D 133/26; C08K 3/08; C09D 5/08; C08F 220/58

(57) ABSTRACT

Polymeric antioxidants of offer the ability to simultaneously control properties such as hydrophobicity/hydrophilicity, adhesion to a substrate, and glass transition temperature. The polymeric antioxidants offer advantages and superior properties to other compounds. Corrosion barriers including a polymeric antioxidant may be formed. A corrosion barrier coating may include multiple layers. The multiple layers may include an epoxy-based barrier layer and a polymeric antioxidant layer. The multiple layers may be discrete or mixed. The polymeric antioxidant layer may be a synthetic polymeric antioxidant that is formed by synthesizing at least one monomer and synthesizing a polymer from the at least one monomer using a controlled radical polymerization technique.

### CROSS-REFERENCES TO RELATED APPLICATIONS

This application claims the benefit under 35 U.S.C. § 119(e) of U.S. Provisional Patent Application No. 62/433,780, filed Dec. 13, 2016, which is incorporated herein by reference in its entirety as if fully set forth herein.

### BACKGROUND OF THE INVENTION

The present invention is directed to synthetic polymeric antioxidants for use as corrosion protection. Currently existing low molecular weight antioxidants include polycatechols with dihydroxybenzene groups, trihydroxybenzene anticorrosion agents, gallate esters, and melamine cyanurate. One of the drawbacks of these antioxidants is that they exhibit poor adhesion to coatings, instead tending to leach from the coatings.

### SUMMARY OF THE INVENTION

The polymeric antioxidants of the present invention offer the ability to simultaneously control properties such as hydrophobicity/hydrophilicity, adhesion to a substrate, and glass transition temperature. As such, these novel antioxidants offer advantages and superior properties to the compounds that currently exist in the prior art. The present invention is directed to synthetic polymeric antioxidants comprising linear homopolymers and copolymers containing a variety of dihydroxy- and trihydroxybenzyl amides and esters. The polymers of the present invention are distinct from the prior art as they are made using an environmentally-friendly preparation procedure and enable simultaneous and/or independent control of (a) hydrophobicity; (b) glass transition temperature, and (c) adhesion properties of the polymers.

An embodiment of the claimed invention is directed to a method for the synthesis of synthetic polymeric antioxidants comprised of synthesizing at least one monomer; and synthesizing a polymer using controlled radical polymerization techniques. At least one monomer is a polyphenol. In certain embodiments, the monomer may be copolymerized with another monomer. In other embodiments, the synthesized antioxidant is a homopolymer.

A further embodiment of the claimed invention is directed to a corrosion barrier coating comprised of multiple layers, such as, an epoxy-based barrier layer and polymeric antioxidant layers. In this embodiment, the layers are discrete, multilayered, or mixed. In certain embodiments, the corrosion barrier may be deposited using dip-deposition, spin-deposition, or spray-deposition techniques. In other embodiments, the corrosion barrier may be deposited using a single step adsorption technique or a sequential deposition of multiple layers. Due to good miscibility, antioxidant polymers may be used additives to epoxy matrix. The antioxidant polymers can improve corrosion resistance of the epoxy matrix, increase surface hydrophobicity, and potentially increase the life time of epoxy coatings by decreasing the damage from radical-involved oxidation. Moreover, because of the significant transparency of epoxy coatings containing up to 10 wt % of polymeric antioxidant additives, the epoxy coatings can aid in visual detection of corrosion products.

### BRIEF DESCRIPTION OF THE DRAWINGS

A more complete understanding of embodiments of the present invention may be obtained by reference to the following Detailed Description when taken in conjunction with the accompanying Drawings wherein:

FIG. 1A is a schematic representation of a chemical structure of antioxidant copolymers;

FIG. 1B is a schematic representation of a chemical structure of antioxidant homopolymers;

FIG. 2A is a schematic representation of synthesis of N-hexyl methacrylamide;

FIG. 2B is a schematic representation of synthesis of N-(3,4,5-trimethoxybenzyl) methacrylamide;

FIG. 3 is a schematic representation of synthesis of a brominated monomer;

FIG. 4 is a schematic representation of synthesis of P-10-3-HM copolymer, where 10 is the molar percentage of 3-methoxybenzyl units;

FIG. 5 is a schematic representation of deprotection of P-10-3-HM;

FIG. 6 is a graph illustrating open circuit potential measurements for bare aluminum alloy 2024 and aluminum alloy 2024 coated with antioxidant polymer immersed in 3.5 wt % NaCl solution over a 5 day period;

FIG. 7A is a graph illustrating electrochemical impedance spectra for aluminum alloy 2024 immersed in 3.5 wt % NaCl solution over a 5 day period rendered in a Nyquist representation;

FIG. 7B is a graph illustrating a Bode representation;

FIG. 8A is a graph illustrating electrochemical impedance spectra for aluminum alloy 2024 coated with antioxidant polymer immersed in 3.5 wt % NaCl solution over a 5 day period rendered in a Nyquist representation;

FIG. 8B is a graph illustrating a Bode representation;

FIG. 9A is a schematic representation of an epoxy component;

FIG. 9B is a schematic representation of a curing agent;

FIG. 9C shows schematic representations of P2H₁₅Hex, P3H₁₅Hex, and PHex;

FIG. 10A, FIG. 10B, FIG. 10C and FIG. 10D show EIS spectra including Nyquist and Bode representations for coatings immersed for 100 days in aerated 3.5 wt % NaCl solution at room temperature;

FIG. 11A illustrates |Z|_{0.01 Hz} values vs Days for P2H₁₅Hex, P3H₁₅Hex, epoxy, and Phex;

FIG. 11B illustrates |Z|_{0.01 Hz} values vs Days for P2H₁₅Hex and epoxy; and

FIG. 12 is a graph illustrating absorbance of 3.5% NaCl solutions after a 100-day immersion of bare epoxy-based coating and coatings containing P2H₁₅Hex, P3H₁₅Hex, or PHex additives after 1 and 3 days of immersion with tannic acid as an additive.

### DETAILED DESCRIPTION

Embodiment(s) of the invention will now be described more fully with reference to the accompanying Drawings. The invention may, however, be embodied in many different forms and should not be construed as limited to the embodiment(s) set forth herein.

The invention should only be considered limited by the claims as they now exist and the equivalents thereof.

Embodiments of the invention are directed to a family of synthetic antioxidant polymers (homo- and copolymers) as components of antioxidant coatings. The family of polyphenolic polymers is characterized by having two or three adjacent hydroxyl groups in the aromatic ring of the repeating units. In certain embodiments, the polymers are synthesized by using controlled radical polymerization techniques. The polymers contain functional groups that simultaneously provide adhesion to metal surfaces and significant antioxidant activity to the polymer. In certain embodiments, the polymers may be synthesized using reversible addition-fragmentation chain transfer (RAFT) polymerization. In certain further embodiments, polymer hydrophobicity and antioxidant activity may be modulated by copolymerizing monomers. In other embodiments, some copolymerizing monomers may contain 3,4,5-trihydroxy benzyl, 3,4-dihydroxy-5-bromo benzyl, and alkyl moieties. In certain embodiments, monomers may be synthesized by reacting the corresponding amines with methacrylic anhydride. Methoxy derivatives of the monomers may be chosen as precursors for the synthesis of the polyphenolic monomers, due to the capability of unprotected polyphenols to oxidation.

In certain further embodiments, coatings containing synthetic antioxidant molecules may be adhered to a metal surface (in certain embodiments, this metal may be aluminum or steel) to enhance anticorrosion activity by exploiting the chemical reactivity of synthetic antioxidants. In a further embodiment, the synthesized polymer may be used as a primer layer in multilayered commercial anticorrosion coatings, or in other further embodiments, the synthesized polymer may be additionally mixed with an epoxy-based barrier layer to provide an additional layer of anticorrosion protection. In addition to mixing with epoxy, magnesium (Mg) or aluminum (Al) particles can be added to the coatings to provide additional corrosion protection via a sacrificial mechanism.

In certain further embodiments, various deposition techniques may be used to deposit the coatings including dip, spin, and spray-assisted deposition. In certain further embodiments, the coatings may be deposited using single-step adsorption while in other embodiments, coatings may be constructed using deposition of multiple layers.

Embodiments of the invention are directed to the chemistry of linear homo- and copolymers containing a variety of dihydroxy- and trihydroxyb amides and esters.

The polymers of the claimed invention are distinct from the prior art as they are based on an environmentally-friendly preparation procedure and enable simultaneous and/or independent control of (a) hydrophobicity; (b) glass transition temperature, and (c) adhesion properties of the polymers. All these features are important for including these polymers in the anticorrosion polymer coatings.

### Working Examples

### Experimental Results of Producing an Antioxidant Coating

### I. Synthesis of Antioxidant Copolymers and Coating Deposition

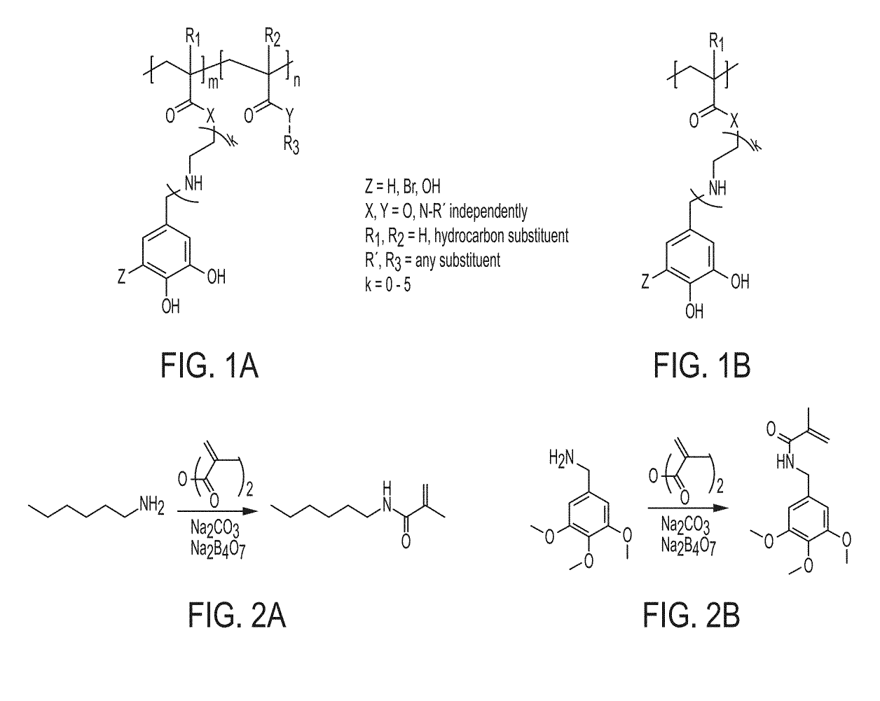

Generalized structures of the antioxidant polymers are presented in FIG. 1. The following procedure was used to synthesize a random copolymer of N-hexyl methacrylamide and N-(3,4,5-trihydroxybenzyl) methacrylamide containing 10 molar percent of polyphenol moieties (P-10-3-HH).

2,2′-Azobis(2-methylpropionitrile) (AIBN, Sigma) was purified by recrystallization from methanol. All other reagents were used as received. Benzylamine, hexylamine, 2-cyano-2-propyl dodecyl trithiocarbonate (CPD-TTC), boron tribromide, tetrahydrofuran (THF), 1,4-dioxane, n-hexane, chlorobenzene, hydrochloric acid, sodium hydroxide were purchased from Sigma. 3,4,5-trimethoxybenzylamine, methacrylic anhydride, borax, anhydrous magnesium sulfate, dichloromethane were purchased from Alfa Aesar. Sodium carbonate, nitric acid, and methanol were purchased from Macron. All monomers were synthesized by reacting the corresponding amines with methacrylic anhydride. N-hexyl methacrylamide was synthesized as follows (FIG. 2A). 15.0 grams of borax (decahydrate) [39.3 mmol] and 15.0 grams of anhydrous sodium carbonate [142 mmol] were dissolved in 400 mL of water. The solution was purged with argon for 120 min, followed by the addition of 13.2 mL [99.9 mmol] of hexyl amine and 15-min stirring. 17.0 mL of methacrylic anhydride was dissolved in 50 mL of freshly distilled THF and was added dropwise to hexyl amine solution at vigorous stirring (˜1000 rpm). After stirring for 24 hours at room temperature, the mixture was extracted with dichloromethane (150 mL) three times. The extract was washed sequentially once with 0.1 M NaOH, twice with water, once 0.1 M HCl, twice with water, and dried over anhydrous MgSO₄. The solvent was removed under vacuum to yield viscous colorless liquid (yield 74.6%). 1H-NMR (300 MHz, DMSO-d6): δ 5.69 s (1H, CHH═); 5.27 s (1H, CHH); 3.31 s (unknown); 3.02-3.10m (2H, —NHCH₂CH₂—); 3.71-3.73 d (9H—C₆H₂(OCH₃)₃); 2.49 s (solvent), 1.82 s (3H, CH₃—); 1.32-1.45 m (2H, —NHCH₂CH₂—); 1.15-1.28 m (6H, —NHCH₂CH₂(CH₂)₃CH—₃); 0.81-0.86 t (3H, —NHCH₂CH₂(CH₂)₃CH₃).

The synthesis of N-(3,4,5-trimethoxy benzyl) methacrylamide followed the same procedure (FIG. 2B). ¹H-NMR (300 MHz, DMSO-d6): δ 8.2 tb (1H, —NH—); 6.5-6.6 d (2H, C₆H₂(OCH₃)₃; 5.69 s (1H, CHH═); 5.35 s (1H, CHH═); 4.23-4.25 d (2H, —CH₂—); 3.71-3.73 d (9H—C₆H₂(OCH₃)₃); 2.49 s (solvent), 1.87 s (3H, CH₃—).

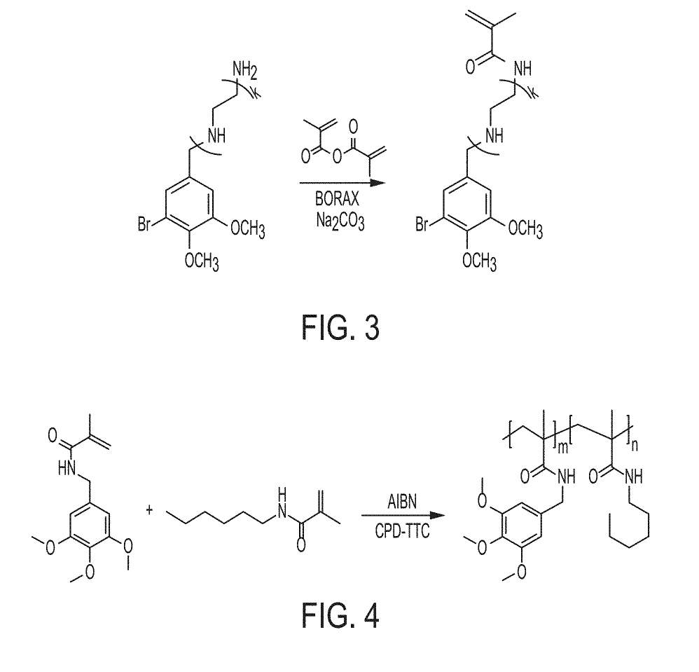

FIG. 3 presents an example of synthesis of another type of monomer which contains a brominated ring. Direct polymerization of monomers containing phenolic groups and a carbon-carbon double bond via free-radical mechanism is complicated by the reactivity of the phenolic side groups, which will participate in a side reaction and prevent polymerization through the double bond. To overcome this problem, monomers with protected hydroxyl groups are to be used for the synthesis (FIGS. 2A, 2B, and 3). To obtain monomer units with varied distributions of electron density within the aromatic ring (and therefore with different antioxidant activity), commercially available amines as well as the products of their bromination should be used. The double bond should be attached to the original and brominated amines through a reaction with methacrylic anhydride (FIG. 3). Chemical structure of the synthesized monomers were assessed using FTIR, H NMR, and ¹³C NMR. Using the monomer shown in FIG. 2A, a random copolymer of N-hexyl methacrylamide and N-(3,4,5-trimethoxy benzyl) methacrylamide (P-10-3-HM) was synthesized as shown in FIG. 4.

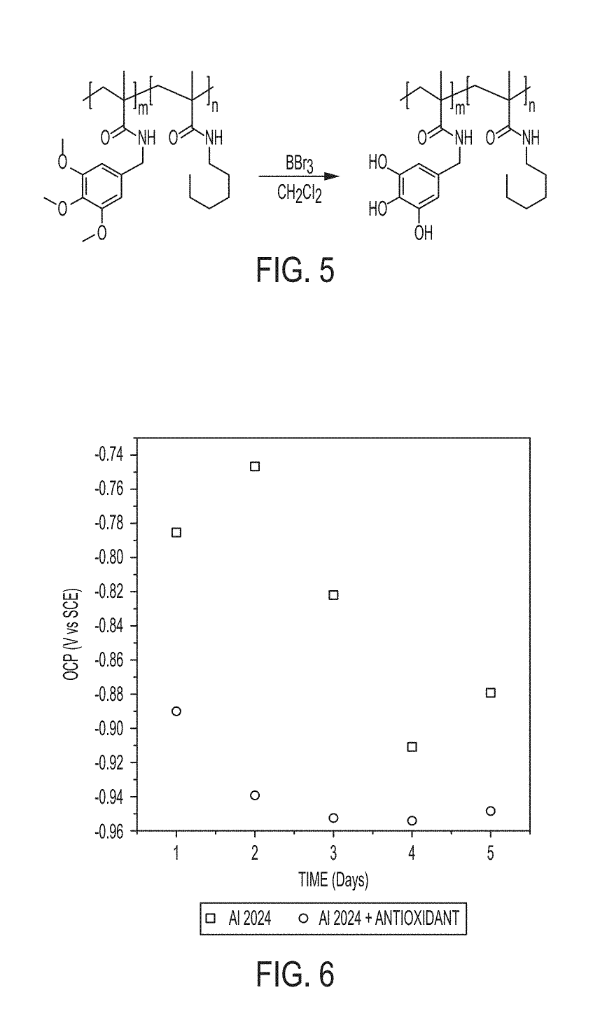

0.500 grams of N-(3,4,5-trimethoxy benzyl) methacrylamide [1.88 mmol] and 2.87 grams of N-hexyl methacrylamide [17.0 mmol] were placed into a Schlenk tube. The tube was frozen with liquid nitrogen, vacuumed, and filled with argon gas. After thawing, 1.50 mL of anhydrous 1,4 dioxane was added, sealed, and stirred until complete dissolution (˜30 min) at room temperature. 2.4 mg of 2,2′-Azobis(2-methylpropionitrile) (AIBN) [0.015 mmol] and 33 L of CPD-TTC [0.096 mmol] were dissolved in 0.500 mL of anhydrous 1,4-dioxane and added to the reaction mixture. After three vacuum-thaw cycles the tube was sealed and heated in an oil bath at 75-80° C. for 48 hours. After cooling to room temperature, 13.0 mL of THF were added to the solution, and the solution was sonicated. The solution was then slowly added dropwise to 250 mL of n-hexane under vigorous stirring. The precipitated white solid was filtered and dried in a vacuum desiccator. The polymer was re-precipitated from THF into water and dried overnight in the vacuum desiccator. Gel Permeation Chromatography (GPC) (using DMF as a solvent and a solvent flow of 0.1 mL/min) has yielded M_{w}=35.2 kDa and PDI=1.28. Deprotection of the polymer was achieved as shown in FIG. 5. Specifically, 0.500 grams of P-10-3-HM was placed into a Schlenk flask, vacuumed and filled with argon gas. 40 mL of anhydrous dichloromethane was then added to the polymers and stirred for about 15 minutes. After three vacuum-thaw cycles, the solution was put in a liquid N₂/chlorobenzene bath (−45° C.) and treated with the 4.20 mL 0.2 M BBr₃ [0.840 mmol] solution in dichloromethane. The mixture was stirred for 30 min, then the flask was removed from the bath and slowly heated to room temperature. The solvent was removed under vacuum, and the yellow solid was treated with 2.00 mL of water and dried in the vacuum desiccator overnight. The final product was a random copolymer of N-hexyl methacrylamide and N-(3,4,5-trihydroxy benzyl) methacrylamide (P-10-3-HH).

Other copolymers and homopolymers can be synthesized using similar procedures. The success of the syntheses is to be monitored using GPC to determine molar mass and dispersity, and by ¹H NMR and FTIR to determine the chemical structure.

### II. Deposition of the Antioxidant Polymers at Metal Surfaces

The coatings can be deposited on metal surfaces of varied roughness using spin-, spray-, or dip-deposition techniques. Plates of 2024 aluminum alloy (15.3 mm×7.6 mm) were used as substrates. The surface was pretreated by sequential immersion of aluminum plates in 5% sodium hydroxide solutions (at 40° C.) and 27% nitric acid (at room temperature), followed by intermediate washing with distilled water. Pretreated plates were dried in a nitrogen gas flow. The pretreated aluminum plates were then dipped in 5 mg/mL solution of P-10-3-HH in methanol and dried in nitrogen flow. The coated plates were then heated for 2 hours at 80° C. The water contact angle of the coating equilibrated at room temperature was 98°.

### III. Electrochemical Measurements

FIG. 6 shows the open circuit potential (OCP) magnitudes of bare aluminum alloy 2024 and aluminum alloy 2024 with a protective layer of antioxidant polymer immersed in 3.5 wt % sodium chloride solution for 5 days. Metallic substrate showed an open circuit potential of −0.79 V vs SCE during the first day of immersion and then it shifted to a more anodic value due to the presence of a native aluminum oxide layer formed on the metallic surface. Following three days of immersion, OCP shifted to more negative values due to breakdown of the passive layer producing a localized attack due to the chloride ions in the electrolyte solution. Also, FIG. 5 shows OCP values for aluminum alloy 2024 coated with the antioxidant polymer are more negative compared to the bare metal. This result can be explained due to the surface pretreatment of the aluminum substrate in which the passive layer was removed to improve adhesion between the metal and the antioxidant polymer. After the first day of immersion, OCP values for the coated sample remained almost constant during the following 5 days of immersion. This stability of the OCP suggests that the antioxidant polymer was providing corrosion protection to the metallic substrate and no activation (corrosion processes) was taking place at the metal/coating interface.

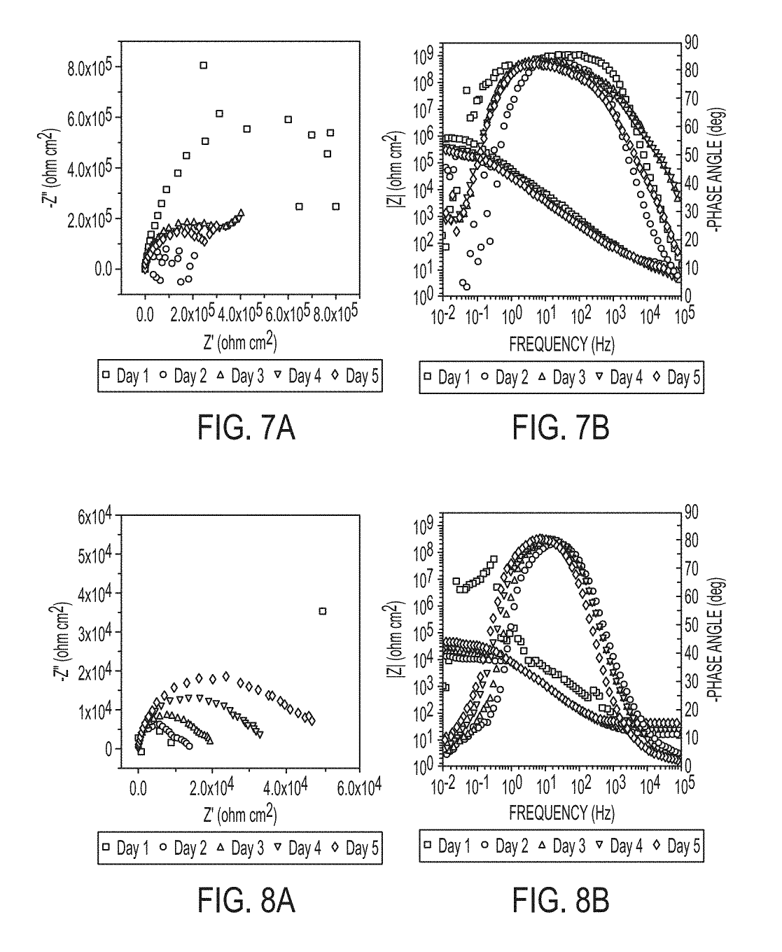

FIGS. 7A and 7B show EIS (electrochemical impedance spectroscopy) spectra for bare aluminum alloy 2024 immersed in 3.5 wt % NaCl solution for 5 days. Nyquist (or complex) representation (FIG. 7A) shows one capacitive loop from high to medium frequencies and a linear behavior at low frequencies characteristic of a mass transfer control process. The capacitive loop at high frequency can be associated with the presence of the aluminum oxide layer formed on the metallic substrate. The mass transfer at low frequency can be attributed to the diffusion control mechanism influenced by a stable layer at the interface. In addition, the Bode plot (FIG. 7B) shows that impedance magnitude at 0.01 Hz decreases with time resulting from corrosion degradation processes at the metallic substrate.

Impedance spectra for the coated aluminum sample are shown in FIG. 8. As demarcated by the Nyquist representation, one capacitive loop is identified during the entire frequency range. This capacitive loop increases its diameter with time suggesting that active corrosion protection was provided by the antioxidant polymer. The phase angle showed only one time constant at 10 Hz related to the dielectric properties of the antioxidant polymer. This behavior indicates that charge transfer processes occurred at the metal substrate and the antioxidant polymer was able to provide corrosion protection to the aluminum surface by an active interfacial mechanism.

### IV. Effect of Antioxidant Polymers on Corrosion Protection

The effect of antioxidant polymers on corrosion protection was studied for copolymers containing 15% of antioxidant repeating units in polymer chains. Specifically, P3H₁₅Hex and P2H₁₅Hex polymers with 15% of N-(3,4,5-trihydroxy)benzyl methacrylamide and N-(3,4-dihydroxy)benzyl methacrylamide antioxidant repeating units, respectively, and 85% of hydrophobic hexyl-containing units were tested. Additionally, a polymer composed solely of hydrophobic units (PHex) was studied as a control sample.

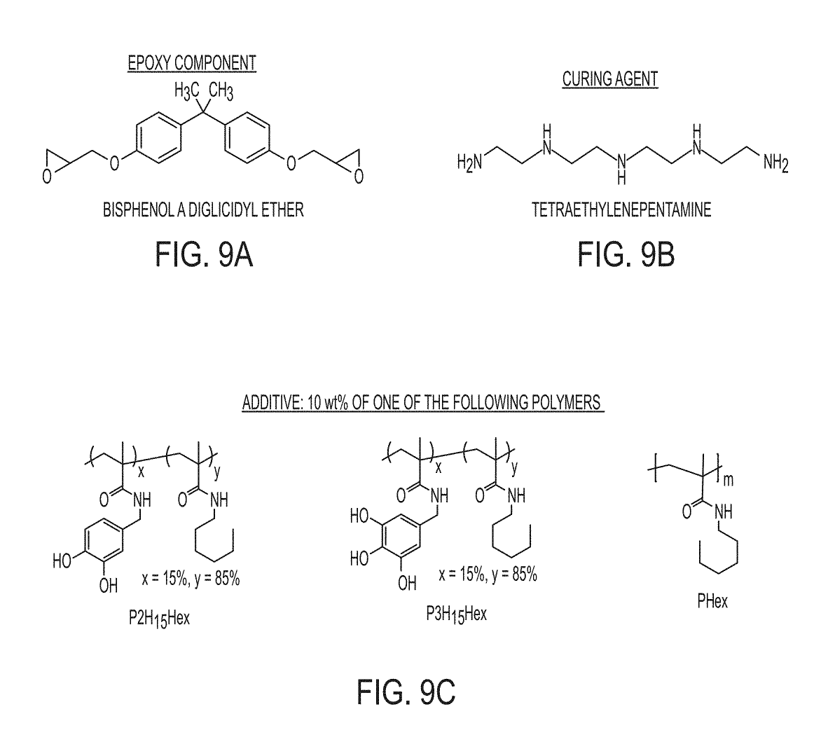

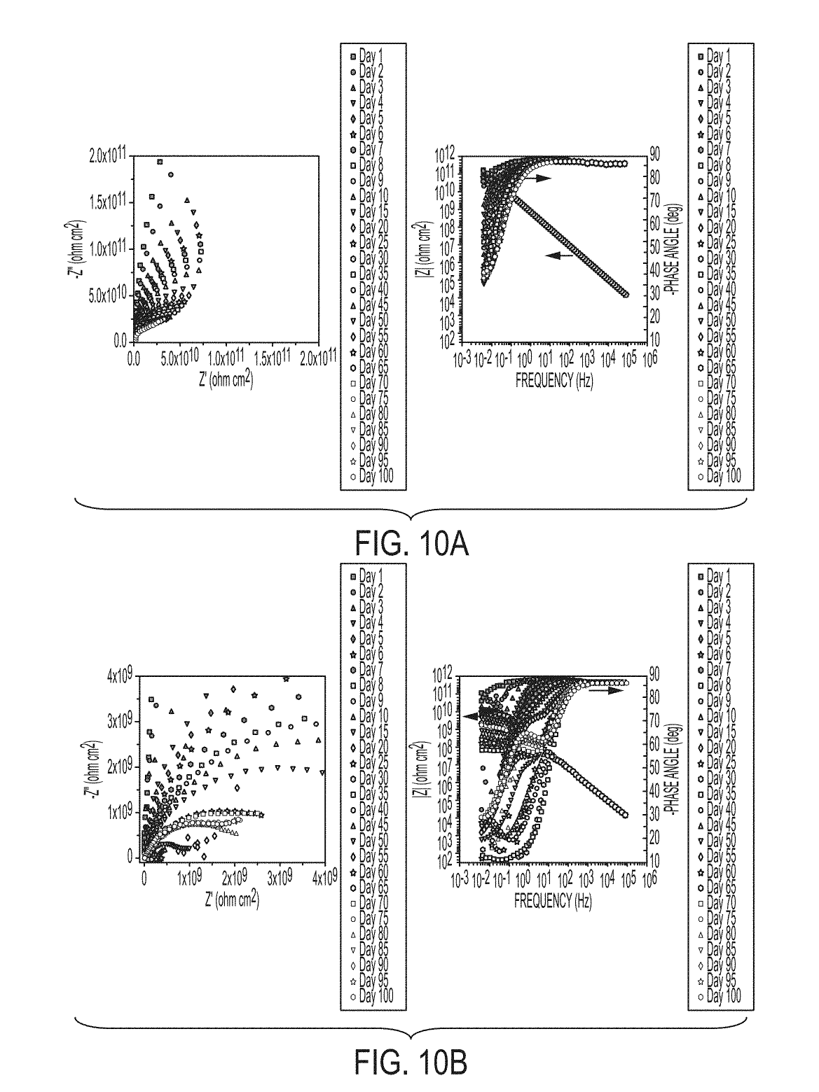

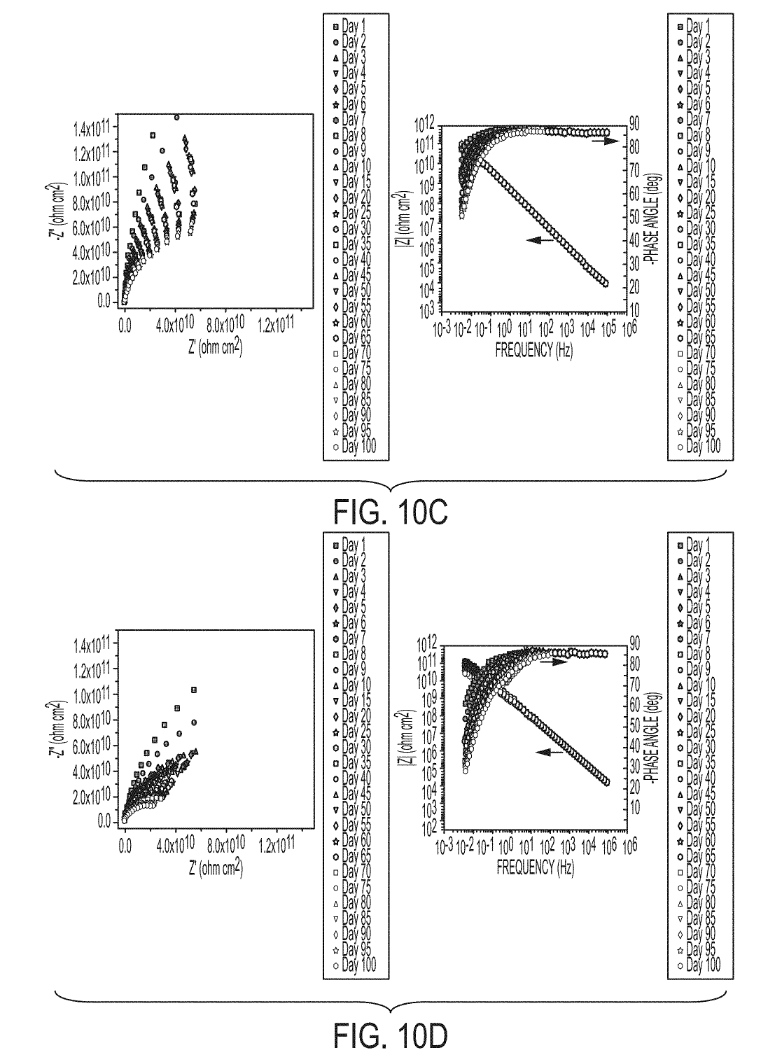

P3H₁₅Hex, P2H₁₅Hex, and PHex were explored as additives to a common polymer anticorrosion coating that provides good barrier protection. In particular, an epoxy formulation was used as a barrier matrix. The formulation included bisphenol A diglycidyl ether as an epoxy component or a component A, and tetraethylenepentamine as a hardener or a component B (for one part (by mass) of a hardener, 6.21 parts of epoxy were used). FIG. 9A is a schematic representation of an epoxy component, FIG. 9B is a schematic representation of a curing agent, and FIG. 9C shows schematic representations of P2H₁₅Hex, P3H₁₅Hex, and PHex.

For coating preparation, about 1 gram of bisphenol A diglycidyl ether was melted at 40° C. and mixed with 10 wt % of an additive (P2H₁₅Hex, P3H₁₅Hex, or PHex). The mixture was stirred at 40° C. for 24 hours. Hardener was then added and the mixture was stirred for a minute and deposited on pretreated aluminum 2024 plates with a film applicator. The coated plates were placed on the hotplate at 85° C. for several minutes and cured in the oven at 85° C. for an hour.

The aluminum 2024 plates were pretreated as follows. The plates (2 inch by 4 inch) were sequentially grinded with P600, P1000, and P1500 sand paper, and polished with a monodisperse diamond paste with a particle size of 9, 3, and 1 μm. The polished plates were sonicated in hexane, ethanol, rinsed with deionized water, and dried in a nitrogen flow. Prior to depositing the coating, the plates were treated with 5% NaOH solution for 2 minutes and with 27% HNO₃ solution for 30 seconds at ambient temperature, rinsed with deionized water, and dried in a flow of nitrogen gas. All coatings had a thickness of about 100 μm. The thicknesses and contact angles for the coatings of varied compositions are presented in Table 1.

TABLE 1
Physical characteristics of anticorrosion epoxy-based coatings.

| Additive | Thickness, μm | Contact Angle of Water, degrees |
|---|---|---|
| None | 120.24 ± 11.9 | 77.0 ± 1.1 |
| P2H₁₅Hex | 108.41 ± 7.25 | 84.1 ± 5.0 |
| P3H₁₅Hex | 116.35 ± 11.3 | 85.6 ± 0.9 |
| PHex | 68.47 ± 5.8 | 88.3 ± 0.9 |

As seen in Table 1, the addition of all poly(methacrylamide)-type additives to the epoxy coatings resulted in an increase of the coatings' contact angles, which could be a result of increased surface hydrophobicity and/or surface roughness. Hydrophobic coatings are more preferable for the use in corrosion protection because their higher water repellency. Corrosion resistance of fabricated coatings was studied with the corrosion immersion test.

Electrochemical impedance spectroscopy (EIS) was performed to evaluate the corrosion performance of the different coatings during immersion for 100 days in a 3.5 wt. % NaCl solution.

The EIS testing was performed in a conventional three electrode cell using a glass cell with 4.67 cm² of exposed area that was sealed to the coated substrate by using an O-ring and a metallic clamp. The electrochemical cell was filled with approximately 25 mL of the testing solution. In this three-electrode configuration, the coated substrate was used as the working electrode, a saturated calomel electrode was used as the reference electrode, and a Pt/Nb mesh was used as the counter electrode. The electrochemical measurements were performed using a Gamry potentiostat/galvanostat/ZRA Reference 600™ and a Faraday cage to mitigate electromagnetic interference. The EIS measurements were carried out over a frequency range of 100 kHz to 10 mHz with 10 points per decade at open circuit potential and using an AC amplitude of 10 mV.

To evaluate the corrosion resistance of the different coatings based on the EIS results, the impedance magnitude at the lowest frequency (|Z|_{0.01 Hz}) was used as an approximation to the polarization resistance of the system, therefore the higher the |Z|_{0.01 Hz} value, the higher the corrosion resistance to the corrosive medium.

FIGS. 10A-10D are graphs illustrating EIS spectra including Nyquist and Bode representations for coatings immersed for 100 days in aerated 3.5 wt % NaCl solution at room temperature. FIG. 10A illustrates epoxy, FIG. 10B illustrates PHex epoxy, FIG. 10C illustrates P2H₁₅Hex epoxy, and FIG. 10D shows P3H₁₅Hex epoxy. The EIS spectrum for the bare epoxy coating (FIG. 10A) showed two different EIS signals during the entire immersion period; during the first 80 days of immersion, the Nyquist representation shows only one time constant and the |Z|_{0.01 Hz} values in the Bode plot were close to 101 ohm cm². This behavior suggests that the epoxy coating provided an excellent barrier protection to the metallic substrate owing presumably to the high crosslinking between its polymeric components. However, after 80 days of immersion, the EIS signal shows the presence of a second time constant at low frequency indicating the initiation of corrosion processes at the surface of the metallic substrate. This time constant at low frequency shows a diffusion-like behavior suggesting that the corrosion process was controlled by the diffusion of reacting species towards and away from the metal/electrolyte interface.

FIG. 10B shows a detrimental behavior in terms of corrosion resistance once the epoxy coating was combined with the P-Hex. From FIG. 10B, it can be seen that the diffusion-like behavior at low frequency appeared at earlier immersion times (approximately at 40 days) compared to the bare epoxy coating. This behavior indicates earlier initiation of active corrosion processes at the metallic substrate suggesting a faster permeability of water and ionic species across the polymeric material. The weakening of the barrier properties of the epoxy coating after introducing the P-Hex can be attributed to poor miscibility of P-Hex in the epoxy matrix that could cause segregation between the two components leading to higher porosity of the coating system and therefore higher susceptibility to diffusion of corrosive species. The phase angle representation in FIG. 10B also shows an additional stage in the degradation process of this coating system, it can be noticed that after 50 days of immersion, the time constant at low frequency disappeared and a new time constant at intermediate frequencies became evident. This time constant can be associated with the formation of a layer of corrosion products due to the active anodic dissolution process. In addition, it is also observed that the phase angle associated with this time constant was increasing overtime implying that buildup of solid corrosion products was taking place at the surface of the metallic substrate.

In contrast to the adverse effect of PHex in the corrosion performance of the epoxy coating, there was a positive influence of the active copolymers on the overall corrosion resistance of the epoxy matrix. As it can be seen from FIG. 10C (P2H₁₅Hex 10 wt. % additive) and FIG. 10D (P3H₁₅Hex 10 wt. % additive), the impedance spectra for these coatings showed a capacitive-like behavior during the entire immersion period confirming the excellent barrier protection of these coatings with no evidence of any corrosion processes taking place at the aluminum substrate. The positive synergistic behavior between these active compounds and the epoxy matrix can be attributed to several aspects including: strong adhesion to the metallic substrate that reduces the susceptibility to blistering and cathodic delamination, chemical interaction between the antioxidant compounds and the aggressive electrolyte providing inhibition of the corrosion processes, and strong barrier protection against corrosive media due to the presence of a large amount of hydrocarbon tails (higher hydrophobicity properties) as well as good miscibility between the components that improves the crosslinking of the entire matrix (higher tortuosity pathways for the diffusion of species).

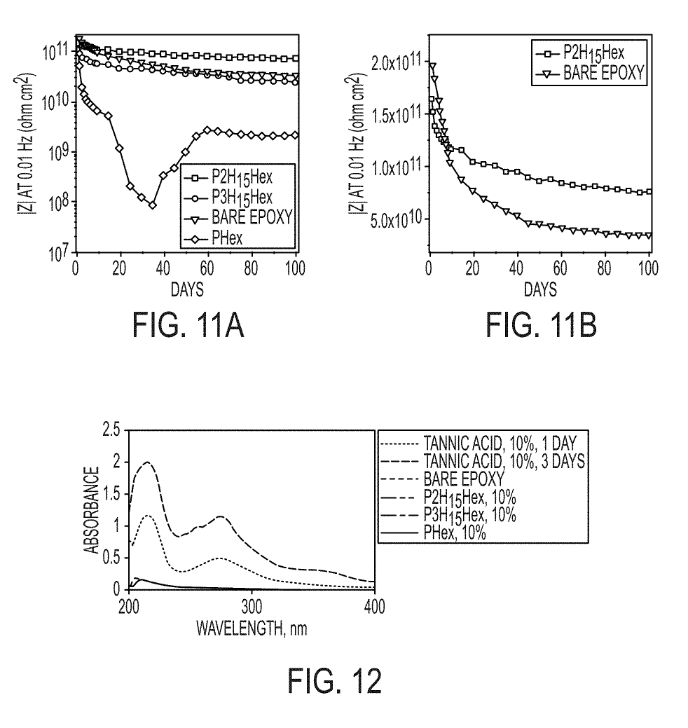

FIGS. 11A and 11B show the evolution of |Z|_{0.01 Hz} values during the entire immersion period for the different test coatings. |Z|_{0.01 Hz} provides an estimation of the corrosion resistance of the coating system, therefore high values of |Z|_{0.01 Hz} indicate high resistance of the material to degradation by corrosive species. FIG. 11A illustrates |Z|_{0.01 Hz} values vs Days for P2H₁₅Hex, P3H₁₅Hex, epoxy, and PHex. FIG. 11B illustrates |Z|_{0.01 Hz} values vs Days for P2H₁₅Hex and epoxy. FIG. 11A shows that P2H₁₅Hex epoxy provided the highest corrosion resistance among all coating systems. It is also evident that the |Z|_{0.01 Hz} values did not significantly change during the entire immersion period, suggesting that this coating provided an effective barrier protection for the diffusion of water and ionic species. The evolution of |Z|_{0.01 Hz} for epoxy, P3H₁₅Hex epoxy, and P3H₁₀₀ epoxy was slightly different to the behavior observed for P2H₁₅Hex, these coatings showed a small decrease of the |Z|_{0.01 Hz} values during the first 50 days of immersion from initial values close to 10¹¹ ohm cm² to values around 4×10¹⁰ ohm cm² and an almost constant behavior for the rest of the immersion time. This behavior indicates that a higher amount of electrolyte was diffusing into these coatings causing an increase in the ionic conductivity of the coatings and subsequently a deterioration in the corrosion resistance of the material. The plateau behavior after 50 days of immersion can be related to possible saturation of the coating with the corrosive solution. A clear distinction in the evolution of |Z|_{0.01 Hz} can be noticed for the PHex epoxy. FIG. 11A shows a dramatic decrease of |Z|_{0.01 Hz} during the first 40 days of immersion, which is correlated with a rapid penetration of electrolyte into the coating and the initiation of corrosion processes at the surface of the substrate. After 40 days of immersion, |Z|_{0.01 Hz} increased for up to 70 days suggesting that corrosion processes were taking place at the substrate leading to the formation and growth of solid corrosion products that provided an extra barrier layer for further corrosion degradation. Finally, after 70 days, |Z|_{0.01 Hz} remained almost constant indicating that a steady state condition was achieved in which the rate for the formation/growth of corrosion products became equal to the rate for the anodic dissolution process.

All antioxidant polymers had good miscibility with epoxy matrix. Good miscibility of the additives with the epoxy coatings enabled direct observation of the metal surface under the coatings.

### V. Non-Leachability of Polymeric Antioxidant Additive

An important property of coatings is non-leachability of the polymeric antioxidant additive. The immersion solutions were collected after 100 days of the corrosion experiment. The absorbance of these solutions was measured with UV-vis spectrometry. No difference was found between absorbance of the immersion solutions that were in contact with bare epoxy coating, PHex-containing coating, as well as with antioxidant-polymer-containing coatings (FIG. 12). However, for the coating made with tannic acid as an additive (10 wt. %), strong absorbance associated with released tannic acid was detected as soon as after 1 day of immersion, and the absorbance further increased with time. FIG. 12 shows absorbance of 3.5% NaCl solutions after a 100-day immersion of bare epoxy-based coating and the coatings containing P2H₁₅Hex, P3H₁₅Hex, or PHex additives, and after 1 and 3 days of immersion of the coatings with tannic acid as an additive.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A method for synthesis of synthetic polymeric antioxidants comprising:
synthesizing at least one monomer; and
synthesizing a polymeric antioxidant using a controlled radical polymerization technique.

2. The method of claim 1, wherein the synthesized polymeric antioxidant contains alkyl or benzyl substituents and comprises an aromatic ring having substituents selected from H, Br, OH.

3. The method of claim 1, wherein functional groups of the synthesized polymeric antioxidant provide adhesion to metal surfaces and antioxidant activity.

4. The method of claim 1, wherein the controlled radical polymerization technique is a reversible addition-fragmentation chain transfer.

5. The method of claim 1, wherein polymer hydrophobicity and antioxidant activity may be modulated by copolymerizing monomers.

6. The method of claim 1, wherein the synthesized polymeric antioxidant is a homopolymer.

7. The method of claim 1, wherein the synthesized polymeric antioxidant is a copolymer.

8. The method of claim 1, wherein the synthesized polymeric antioxidant is linear.

9. The method of claim 1, wherein at least one monomer is a polyphenol.

10. The method of claim 1, wherein the synthesized polymeric antioxidant comprises P2H₁₅Hex.

11. The method of claim 1, wherein the synthesized polymeric antioxidant comprises P3H₁₅Hex.

12. A corrosion barrier coating comprised of multiple layers, the multiple layers comprising:
an epoxy-based barrier layer;
a polymeric antioxidant layer; and
wherein the multiple layers are discrete or mixed.

13. The corrosion barrier coating of claim 12, wherein the polymeric antioxidant layer may be used as a primary layer in a multilayered anticorrosion coating.

14. The corrosion barrier coating of claim 12, wherein the polymeric antioxidant layer may be additionally mixed with the epoxy-based barrier layer.

15. The corrosion barrier coating of claim 12, wherein the polymeric antioxidant layer may be additionally mixed with magnesium (Mg) or aluminum (Al) particles.

16. The corrosion barrier coating of claim 12, wherein the corrosion barrier coating was deposited using a dip-deposition, spin-deposition, or spray-deposition technique.

17. The corrosion barrier coating of claim 12, wherein the corrosion barrier coating may be deposited using a single step adsorption technique.

18. The corrosion barrier coating of claim 12, wherein the corrosion barrier coating may be constructed using deposition of multiple layers.

19. The corrosion barrier coating of claim 12, wherein the polymeric antioxidant layer comprises P2H₁₅Hex.

20. The corrosion barrier coating of claim 12, wherein the polymeric antioxidant layer comprises P3H₁₅Hex.
